(19) United States
(12) Patent Application Publication
(10) Pub. No.: US 2007/0095368 A1
(43) Pub. Date: May 3, 2007

(54) Methods of removing a conformal coating, related processes, and articles

(75) Inventors: David N. Girard, Tampa, FL (US); Robert E. Jeter, Largo, FL (US)

Correspondence Address: Honeywell International Inc., Law Dept. AB2, 101 Columbia Rd., Morristown, NJ, 07962, US

(73) Assignee: Honeywell International Inc.

(21) Appl. No.: 11/261,062

(22) Filed: Oct. 27, 2005

(51) Int. Cl. B08B 3/00; C23D 17/00

(52) U.S. Cl. 134/38; 134/26

(57) ABSTRACT

The present invention relates to methods of removing a conformal coating from an article, related processes, and articles. According to one aspect of the present invention, a process of removing at least a portion of a conformal coating from an article includes the steps of providing an article that includes a conformal coating, providing a containment structure on the article such that the containment structure surrounds an area that includes at least a portion of the conformal coating, providing an amount of a cleaning solvent in the area surrounded by the containment structure and in contact with the conformal coating within the area, and allowing the cleaning solvent to contact the conformal coating within the area in a manner so as to help remove at least a portion of the conformal coating. The amount of cleaning solvent is effective to help remove at least a portion of the conformal coating within the area.

### FIELD OF INVENTION

The present invention relates to methods of removing a conformal coating from an article, related processes, and articles. More specifically, the present invention relates to removing at least a portion of a conformal coating from an article (e.g., a circuit card assembly) by providing a containment structure on a surface of the article to help remove/strip the conformal coating material surrounded by the containment structure. For example, such a containment structure can be provided that is effective to contain a cleaning solvent within the area surrounded by the containment structure so as to provide a minimum thickness of the cleaning solvent in contact with the conformal coating material to be removed.

### BACKGROUND

Circuit card assemblies (CCAs) are well known in the electronics industry and typically include one or more electronic components mounted to the surface of a circuit card. Circuit card assemblies typically include a conformal coating of a material that coats the electronic components and exposed circuit card so as to, for example, protect the electronic components on the circuit card from moisture, chemicals, dust, shock, combinations of these, and the like. Conformal coatings can be made out of a variety of materials depending on, e.g., the function of the conformal coating and/or environment in which the conformal coating will be exposed to. Materials that are effective for use in conformal coatings include, e.g., material based on acrylics, epoxies, urethanes, parxylenes, silicones, combinations of these, and the like. Urethane coatings are preferred for some uses because urethane coatings tend to have good dielectric properties, protect against fungus, moisture, corrosion, thermal shock, and chemical environments (e.g., exhibit a relatively high resistance to solvents), and are tough, hard, and abrasion resistant. Because conformal coatings that include urethane material tend to be so durable, they can be extremely difficult to remove, if so desired.

Sometimes, it is desired to remove at least part of a conformal coating from a circuit card assembly or from individual (loose) electronic components that may be used on a circuit card assembly so that one or more electronic components can be replaced, recovered (i.e., salvaged), or combinations thereof. For example, if there is a shortage of one or more particular electronic components during manufacture of a circuit card assembly, the demand for such component(s) can oftentimes be satisfied by removing the conformal coating in a suitable manner from other like component(s) that have a conformal coating and, e.g., are on a CCA that is otherwise intended for disposal (i.e., salvaging one or more components from a CCA that is otherwise intended for disposal).

Particular methods for removing certain conformal coatings have been developed.

For example, one particular process of this type is well-known as localized conformal coating removal. With localized conformal coating removal, a coating stripper (e.g., liquid solvent) can simply be applied, such as by a brush and/or other applicator, as a relatively thin layer of liquid solvent to the coating material to be removed. Such a process may require many applications of stripper depending on, e.g., the thickness of the conformal coating, the type of material the conformal coating is made of, combinations of these, and the like. In addition, controlling where the stripper (e.g., liquid solvent) contacts a particular article, e.g., circuit card assembly, can be particularly difficult. This can be particularly disadvantageous if the location of coating removal is close to sensitive portions of the circuit card assembly.

Another particular process for removing certain conformal coatings is well-known as immersion processing. Immersion processing includes immersing an individual component previously removed from a CCA, an entire article (e.g., a circuit card assembly), and combinations of these, in a stripper (e.g., liquid solvent) and allowing the stripper to contact the entire article to strip (e.g., dissolve) the conformal coating. This process is typically used with a circuit card assembly when the entire circuit card is going to be eventually discarded, thus contacting the whole circuit card assembly with the stripper is relatively less of a concern. However, one potential drawback includes damaging component(s) on the circuit card assembly that are sensitive to undue contact with the stripper and that would be otherwise salvageable. Another potential drawback of the immersion process is that it requires an amount of stripper to immerse the entire article, which can be a waste if a lesser amount is actually required to remove the conformal coating.

There is a continuing need for new and/or improved processes to remove conformal coatings, especially conformal coatings that include urethane material, from circuit card assemblies and related loose electronic components.

### SUMMARY OF THE INVENTION

The present invention relates to new and useful processes for removing at least a portion of a conformal coating from an article, related processes, and articles. More specifically, a process according to the present invention can remove a conformal coating from an article by creating a containment structure or dam around the perimeter of an area that includes the conformal coating that is to be removed. The containment structure is effective to contain cleaning solvent within the area surrounded by the containment structure to help isolate areas on the article that may be sensitive to the cleaning solvent, while at the same time providing an amount of cleaning solvent (e.g., minimum thickness of a layer of cleaning solvent) that is effective over a given time period to help remove at least a portion of, preferably substantially all of, the conformal coating within the area surrounded by the containment structure.

Methods of removing a conformal coating according to the present invention provide significant advantages. For example, a method of removing conformal coating according to the present invention can be particularly useful for removing conformal coating material that includes urethane material, which, as discussed above, can be extremely difficult to remove. Another advantage includes the ability to reduce labor costs because a worker does not necessarily need to be present while the solvent is interacting with the conformal coating. Another advantage is that other salvageable parts on, e.g., a circuit card assembly, that are sensitive to a stripping solvent can be protected via a containment structure according to the present invention. Yet another advantage is that a method of removing a conformal coating according to present invention can be used, regardless of the conformal coating material, where a liquid solvent-based stripper is used to remove the conformal coating.

According to one aspect of the present invention, a process of removing at least a portion of a conformal coating from an article includes the steps of providing an article that includes a conformal coating, providing a containment structure on the article such that the containment structure surrounds an area that includes at least a portion of the conformal coating, providing an amount of a cleaning solvent in the area surrounded by the containment structure and in contact with the conformal coating within the area, and allowing the cleaning solvent to contact the conformal coating within the area in a manner so as to help remove at least a portion of the conformal coating. The amount of cleaning solvent is effective to help remove at least a portion of the conformal coating within the area.

### BRIEF DESCRIPTION OF THE DRAWINGS

FIG. 1 shows a containment structure on the surface of a circuit card assembly for use in removing a conformal coating material according to the present invention.

FIG. 2 shows a process flowchart for removing a conformal coating material, in particular a urethane material, from a section of a circuit card assembly according to a particular embodiment of the present invention.

FIG. 3a shows an electrical component with a metallic surface for use in a circuit card assembly, wherein the metallic surface has markings.

FIG. 3b shows the effect of the use of a cleaning solvent on the markings on the metallic surface in FIG. 3a.

FIG. 4 shows the electrical component in FIG. 3a having a masking material provided on the metallic surface to protect the markings from a cleaning solvent.

FIG. 5 is a cross-sectional, schematic view showing an alternative containment structure according to the present invention.

### DETAILED DESCRIPTION

The embodiments of the present invention described below are not intended to be exhaustive or to limit the invention to the precise forms disclosed in the following detailed description. Rather a purpose of the embodiments chosen and described is so that the appreciation and understanding by others skilled in the art of the principles and practices of the present invention can be facilitated.

As mentioned above, the present invention generally relates to processes of removing conformal coating from an article, related processes, and articles. In certain embodiments, the present invention is directed to removal of urethane conformal coating material as such is commonly used and is more difficult to remove than many conformal coatings made from other material.

Articles that include conformal coating which can be removed according to the present invention include electronic components and assemblies used in the electronic manufacturing industry. More specifically, such articles can include at least a portion of a circuit card assembly such as a loose circuit card assembly component, a circuit card assembly, combinations of these and the like.

According to one aspect of the present invention, a process of removing a conformal coating material from an article includes creating a containment structure around an area that includes a conformal coating to be removed such that the containment structure is effective to contain an amount of cleaning solvent in contact with the conformal coating for a time that is effective to help remove at least a portion of the conformal coating material within the area. In certain embodiments, substantially all of the conformal coating material is removed within the area. This aspect of the present invention will be further described below with particular reference to removing a conformal coating from a section of a circuit card assembly.

A conformal coating is a coating that is applied to and conforms to the shape of at least a portion of, e.g., electrical components, circuit cards, combinations of these, and the like. Conformal coatings are used in the electronics industry to, for example, protect electronic components on a circuit board from moisture, chemicals, dust, shock, and the like.

Conformal coatings and methods of applying them are well-known in the art (see, e.g., U.S. Pat. No. 6,447,847 to Hynes, et al., the entirety of which is incorporated herein by reference). For example, conformal coatings can be applied by dip-coating, spray-coating, flow-coating, combinations of these, and the like.

Conformal coatings can be made of material including acrylics, epoxies, urethanes, parxylenes, silicones, combinations of these, and the like. As mentioned above, conformal coatings that include a urethane material are used in many applications because they are common (readily available commercially) and tend to have good dielectric properties, protect against fungus, moisture, corrosion, thermal shock, and chemical environments (e.g., exhibit a relatively high resistance to solvents), and are tough, hard, and abrasion resistant.

Urethane compositions for use as conformal coatings and methods of making such urethane compositions are well-known. A preferred urethane composition for use as a conformal coating is formed by curing a urethane precursor material via at least ultraviolet (UV) light. UV-curable, urethane precursor material is commercially available, e.g., from Emerson & Cumming, Billerica, Mass., under the trade designation ECCOCOAT UV7993.

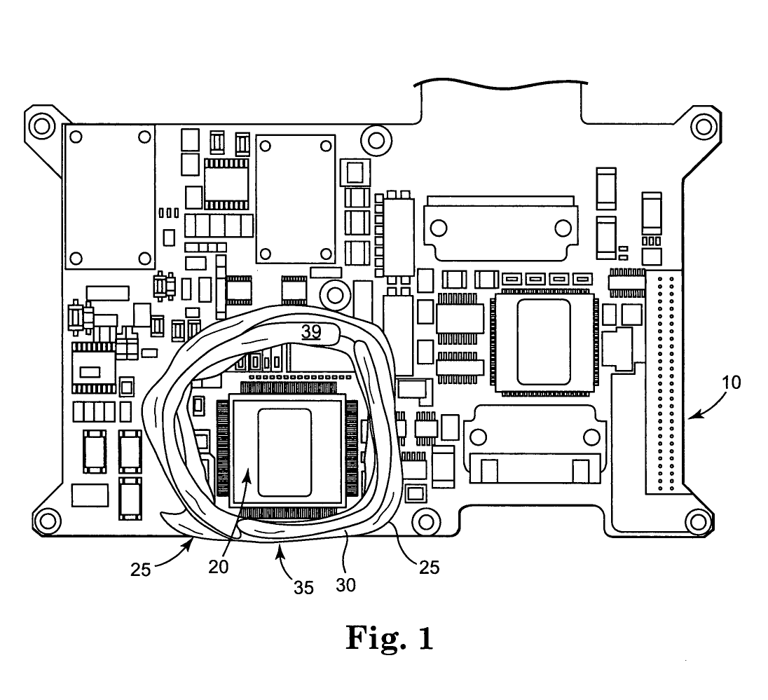

FIG. 1 shows a circuit card assembly 10 having a conformal coating material (appearing relatively transparent) to be removed.

As shown in FIG. 1, area 20 is identified as an area on circuit card assembly 10 that includes at least a portion of the conformal coating on assembly 10 that is to be removed.

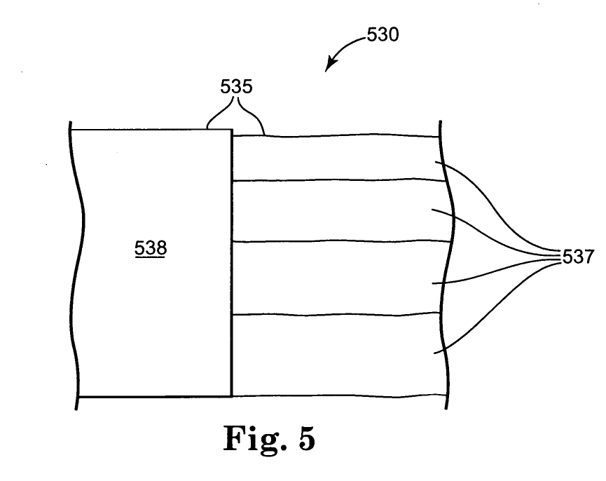

After identifying an area of conformal coating to be removed from an article, a containment structure (dam) is created around the area. As used herein, the term “containment structure” refers to a configuration of one or more materials (dam-like configuration) on a surface of an article (e.g., a circuit card assembly) that surrounds an area in manner effective to contain an amount of cleaning solvent in contact with the conformal coating material for a time that is effective to help remove at least a portion of the conformal coating material within the area. In certain embodiments, substantially all of the conformal coating material is removed within the area. As shown, a containment structure 30 is provided on circuit card assembly 10 in a manner such that containment structure 30 surrounds the perimeter 25 of area 20. Alternatively, a containment structure according to the present invention could be partially made out of added material (e.g., moldable material (discussed below) such as that used to make structure 30) and partially made out of one or more structures/components of the article itself. For example, FIG. 5 is a cross-sectional, schematic view showing a part of containment structure 530. Containment structure 530 has a wall 535 that is formed from layers 537 of moldable material and CCA component 538.

In exemplary embodiments, a moldable material is formed into a wall to help create a containment structure around the area identified for removal of conformal coating such that the containment structure helps contain cleaning solvent (discussed below) within the area surrounded by the containment structure. As shown, wall 35 forms containment structure 30 by layering a bead 39 of moldable material around perimeter 25 of area 20 into wall 35. Alternative embodiments according to the present invention could include forming a moldable material into part of the containment structure while using existing structure(s) or component(s) on a circuit card assembly to also help create the containment structure. For example, an existing circuit card assembly component could form a bottom part of a portion of the containment structure wall and the moldable material could form a top part of the wall. As another example, an existing circuit card assembly component could form an entire wall portion of the containment structure from top to bottom, while an adjacent wall portion of the containment structure could be formed from moldable material from top to bottom (i.e., the moldable material could “bridge” one or more existing circuit card structures/components to form a containment structure) (see, e.g., FIG. 5 discussed above). As yet another example, one or more additional materials (e.g., a piece of metal, plastic, combinations of these, and the like) could be used in combination with the moldable material and/or a circuit card assembly component to help create the containment structure.

Instead of or in addition to layering a bead of moldable material, as shown in FIG. 1, a containment structure according to the present invention could be made by casting a particular material, by layering a material of relatively thin layers (e.g., a material that is too fluid to form beads), combinations of these, and the like.

Also, instead of forming the walls of the containment structure on the containment structure, as shown in FIG. 1, either part of or all of the containment structure could be made remotely from the article and then bonded to the article to help form a containment structure.

Containment structure 30 is effective to contain cleaning solvent with the area 20 surrounded by containment structure 30. Accordingly, as shown, containment structure 30 has a wall 35 that has a height and width that are sufficient to contain an amount of cleaning solvent for time sufficient to remove at least part of, preferably substantially all of, the conformal coating material within area 20. For example, when a conformal coating includes urethane material that is about 3 to 4 mils thick, the height should be sufficient to contain an amount of cleaning solvent (e.g., URESOLVE 411 gel (discussed below)) such that the cleaning solvent can form a layer that is at least about 0.125 inches thick. The thickness of the cleaning solvent layer can vary more or less, hence the size of the containment structure can vary more or less, depending on factors such as conformal coating composition, conformal coating thickness, solvent type, time of contact between solvent and coating, temperature of the process environment (e.g., solvent and/or temperature of the conformal coating), pressure of the process environment, combinations of these, and the like. Advantageously, the containment of cleaning solvent by containment structure 30 helps isolate certain area(s) of circuit card assembly 10 that may be sensitive to a particular cleaning solvent, while at the same time providing an amount of cleaning solvent that is effective to help remove at least part of, preferably substantially all of, the conformal coating.

A containment structure for use in the present invention is preferably made out of material that is chemically compatible with the article (e.g., circuit card assembly 10), including conformal coating material, and the cleaning solvent. Accordingly, a containment structure material for use in the present invention can be selected based on the composition of the article, including conformal coating material, and/or the solvent to be used to remove the conformal coating material. With respect to the cleaning solvent, a containment structure is preferably made out of material that is chemically resistant to the cleaning solvent and that does not unduly affect the cleaning solvent (e.g., inactivate the cleaning solvent). Materials that can be used to provide a containment structure according to the present invention are well-known. A preferred moldable material for making a containment structure according to the present invention includes solder masking material. A particularly preferred solder masking material is commercially available from KESTER®, Des Plaines, Ill., under the trade designation TC-533. KESTER® solder masking-material is a liquid-like material that has sufficient integrity to form a bead (e.g., bead 39) in contact with a CCA. As the KESTER® solder masking-material cures, the portion in contact with the CCA bonds to the CCA in a manner sufficient to contain an amount of cleaning solvent placed in contact with the conformal coating for a time that is effective to help remove at least a portion of the conformal coating material (e.g., such masking material bonds to the CCA during curing so as to prevent solvent passing between the cured masking material and the adjacent surface of the CCA). Advantageously, although this material can bond to a CCA so as to prevent the solvent from leaking through the containment structure, it can be relatively easy to remove when done such as by using a tweezers (discussed below). Also, an adhesive or sealant could be used alone or in combination with a containment structure material such as KESTER® solder masking-material to help the containment structure material bond to the to the CCA so as to help prevent solvent passing between the containment structure and the adjacent surface of the CCA. Suitable sealants/adhesives for such use are well-known in the art and include, e.g., the KESTER® solder masking-material.

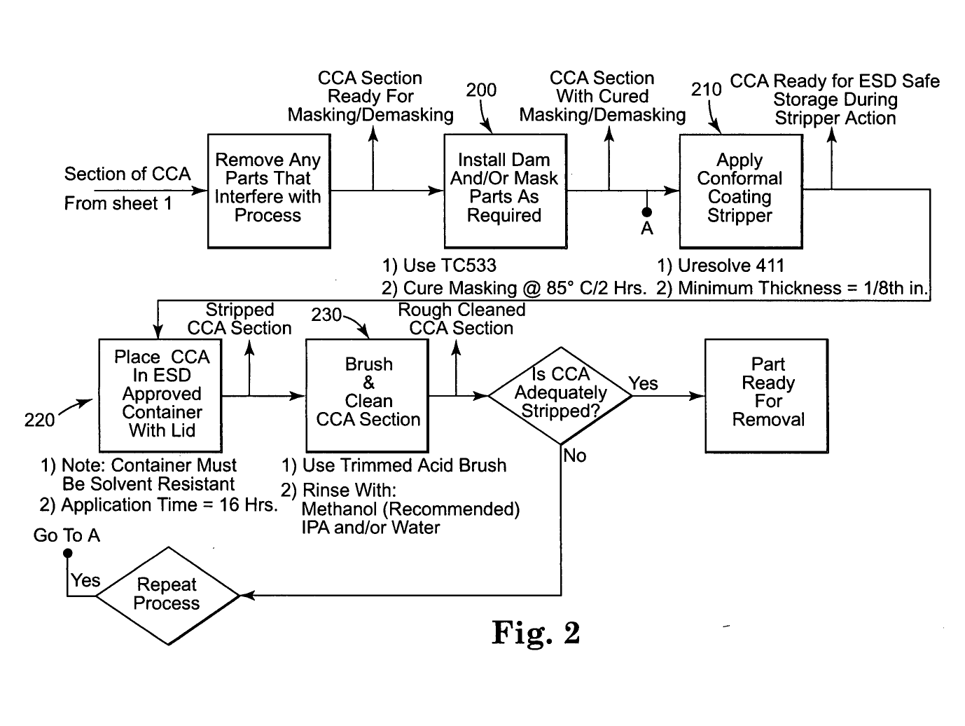

As mentioned, a containment structure according to the present invention is preferably formed out of material that is compatible with the cleaning solvent used to remove the conformal coating material (e.g., urethane material). With this objective in mind, certain solder masking materials (e.g., TC-533 from KESTER®) may need to be baked after forming the material into a containment structure so as to cure the material and help prevent the material from inactivating the cleaning ability of the cleaning solvent. As indicated by step 200 in FIG. 2, a typical baking/curing step for TC-533 solder mask material includes subjecting the solder mask material to a temperature of about 85° C. for about 2 hours. TC-533 solder mask material can be cured at room temperature as well, but may take a longer time to cure.

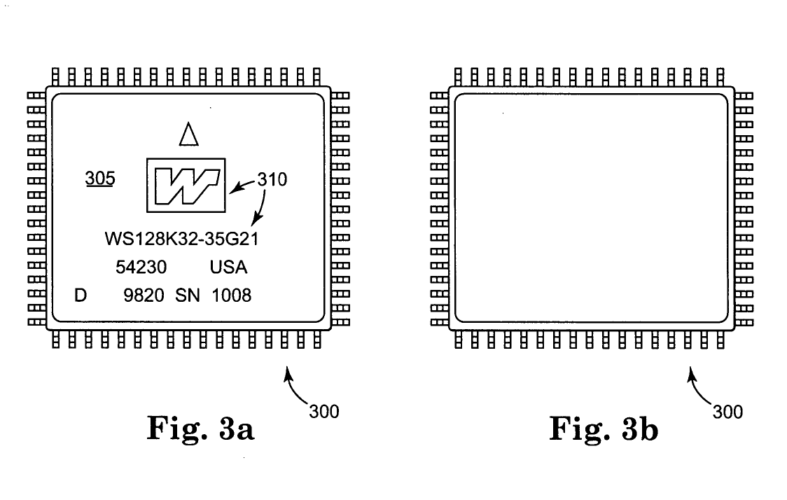

Sensitive portions of an article (e.g., components, marking, labels, combinations of these, and the like) may need to be protected if there is a risk of the cleaning solvent or other process fluids unduly affecting such portions (e.g., removing at least part of a marking and/or label, damaging a component, combinations of these, and the like). For example, FIG. 3a shows an electrical component 300 for use in a circuit card assembly, wherein the electrical component 300 has a metallic surface 305 with markings 310. FIG. 3b shows the effect a cleaning solvent (e.g., URESOLVE 411 gel (discussed below)) can have on the markings 310 shown in FIG. 3a. Such a cleaning solvent can virtually remove the markings 310.

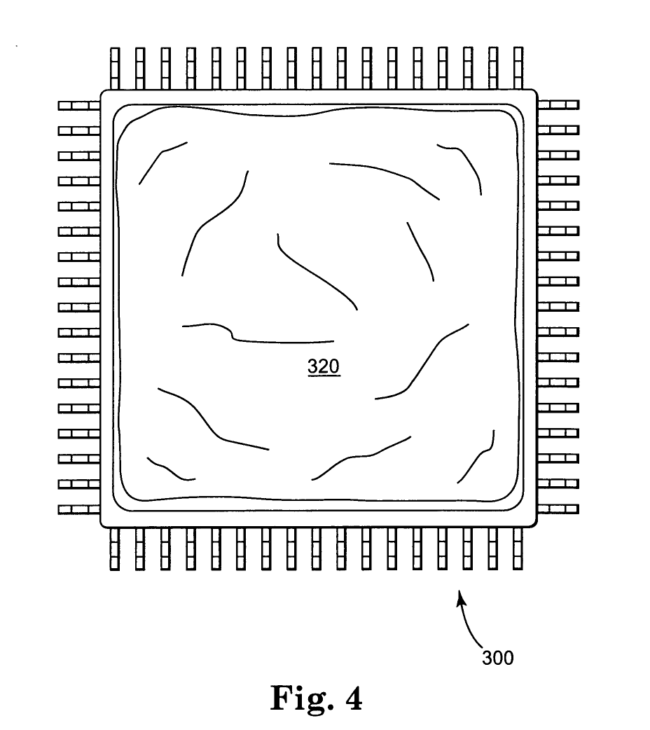

Accordingly, a process according to the present invention can include applying a protective masking material to one or more sensitive portions of an article (e.g., markings 310). FIG. 4 shows the electrical component 300 in FIG. 3a having a protective masking material 320 placed over the metallic surface 305 to protect the markings 310 from a cleaning solvent.

Preferably, protective masking material that is compatible with the article and cleaning solvent is used. Materials that are suitable for use as a protective masking material in processes according to the present invention are well-known. For example, TC-533 solder mask material (discussed above) is used as a protective masking material to protect sensitive portions of an article (e.g., components, marking, labels, combinations of these, and the like). As discussed above with respect to forming containment structure 30, solder mask material (e.g., TC-533) may need to be cured (e.g., for about 2 hours at about 85° C.) prior to applying cleaning solvent.

After a containment structure is created on an article according to the present invention, a cleaning solvent can be provided in the area (e.g., area 20) surrounded by the containment structure (e.g., containment structure 30) so as to contact the conformal coating to be removed. The cleaning solvent is provided in an amount that is effective to help remove at least part of, preferably substantially all of, the conformal coating within the area surrounded by the containment structure. As indicated by step 210 in FIG. 2, an exemplary amount of cleaning solvent includes an amount that forms a layer of cleaning solvent that is at least about 0.125 inches thick when removing, e.g., a urethane conformal coating having a thickness of about 3 to 4 mils.

The amount of cleaning solvent provided in the area surrounded by the containment structure is allowed to contact the conformal coating under conditions (e.g., time, temperature, atmosphere, and the like) so as to dissolve the conformal coating in manner that helps remove at least part of, preferably substantially all of, the conformal coating within such area. For example, the amount of cleaning solvent can be allowed to contact the conformal coating for at least about 6 hours, preferably at least about 8 hours, even more preferably about 10 hours, and even more preferably at least about 16 hours.

The amount of cleaning solvent and the conditions under which the cleaning solvent is allowed to contact a conformal coating so as to help remove at least part of, preferably substantially all of, the conformal coating can vary depending on factors such as composition of the conformal coating, conformal coating thickness, combinations of these, and the like.

In certain embodiments, the amount of cleaning solvent forms a layer having a thickness such that the cleaning solvent can help remove at least part of the conformal coating. For example, at least about ( 1/64) inches thick, at least about ( 1/32) inches thick, at least about ( 1/16) inches thick, or even at least about (⅛) inches thick.

Optionally, a conformal coating removal process according to the present invention may also include one or more steps to control the environment surrounding the article at least while the cleaning solvent is allowed to contact the conformal coating. For example, a “skin” layer may be caused to be formed on the top surface of the solvent so as to help prevent migration and/or thinning of the thickness of the solvent layer while the solvent is contacting the conformal coating to be removed. Such a skin layer can be formed by, e.g., causing a gas (e.g., air) to move across the surface of the cleaning solvent contained by the containment structure for a time (e.g., several minutes) to cause the cleaning solvent to partially dry-out on the surface exposed to the adjacent gaseous environment (e.g., air), thereby creating a “skin” layer.

Another example of helping control the environment surrounding the article, as indicated by step 220 in FIG. 2, includes placing the article in a covered container during at least part of the time that the cleaning solvent is allowed to contact the conformal coating. Placing the article in a container may be in addition to or in lieu of forming a skin layer on the top surface of the solvent. Yet another example of helping control the environment surrounding the article includes, in addition to or in lieu of a container and/or skin layer, placing a cover or cap on top of the containment structure.

Cleaning solvents suitable for removing conformal coatings are well-known. Any cleaning solvent that is effective based upon removal of any conformal coating can be used in the present invention so long as the containment structure material is selected to be sufficiently resistant to the solvent while the solvent contacts the conformal coating for a time to help remove at least part of, preferably substantially all of, the conformal coating. A particularly preferred cleaning solvent for removing urethane conformal coating is commercially available from Dynaloy, Inc., Indianapolis, Ind. under the trade designation URESOLVE 411 gel.

After allowing the cleaning solvent to contact the conformal coating material for a suitable time, the solvent can be removed by methods known in the art. Preferably, the area that has been identified for conformal coating material removal is rinsed to remove any residual solvent and conformal coating material that has been dissolved and/or loosened. Any suitable rinsing fluid can be used such as, e.g., water, isopropyl alcohol, combinations of these, and the like. It has surprisingly been found that a rinsing liquid including methanol works extremely well in rinsing cleaning solvents such as URESOLVE 411 from an article.

After rinsing, the article (e.g., section of a circuit card assembly or component) can be inspected by methods known in the art (e.g., via visual methods and the like) and determined whether the article is sufficiently clean of conformal coating, whether one or more cleaning steps, including cleaning steps according to the invention, need to be performed or repeated at least once, or whether the article cannot be recovered.

Optionally, in preferred embodiments of the present invention, the conformal coating can also be scrubbed in a manner that is effective to help the cleaning solvent remove at least part of, preferably substantially all of, the conformal coating. For example, as indicated by step 230 in FIG. 2, after allowing the cleaning solvent to contact the conformal coating for an effective amount of time to at least help soften the conformal coating, the conformal coating is scrubbed to help remove the conformal coating. After scrubbing, the solvent and conformal coating can be immediately rinsed from the article as described above or the cleaning solvent can be allowed to contact the conformal coating for an additional time period. Any suitable scrubbing equipment can be used to perform such scrubbing including, e.g., an acid brush in which the bristles are trimmed to about 0.125 to about 0.25 inches.

Care is typically used if scrubbing is to be performed because, e.g., as discussed above, although a preferred containment structure material, KESTER® solder masking-material, can bond to a CCA to prevent cleaning solvent from leaking through the containment structure, the cured KESTER® solder masking-material is relatively easy to remove when done (e.g., with a tweezers). Accordingly, care should be taken not to unduly damage the containment structure during scrubbing so as to not create a passage for cleaning solvent to leak from the containment structure during scrubbing and/or if additional cleaning solvent is to be dispensed into the containment structure after scrubbing.

When the conformal coating removal process is complete, the CCA and/or removed components can be cleaned by methods which are well-known. When the containment structure is no longer needed, it can be removed or, if the CCA to which it is attached to is to be discarded, the CCA along with the containment structure can be appropriately discarded according to disposal methods for such materials. If the containment structure is to be removed, it can be removed using any method suitable for removing the material of which the containment structure is made without unduly affecting the CCA to which it is adhered. For example, as discussed above, a preferred containment structure material, KESTER® solder masking-material, can be removed, after it has cured, by using a tweezers.

After such cleaning, a CCA and/or individual component(s) can be tested for any contamination and, if appropriate, can be subjected to additional cleaning procedures to remove contamination to within acceptable levels. For example, ionic testing can be performed to test for the presence of ionic contamination (e.g., salts, fluxes, corrosives, combinations of these, and the like). Such ionic testing methodologies are well-known and include, e.g., the standard well-known as J-STD-001.

Advantageously, a process for removing conformal coating according to the present invention does not necessarily require a pre-cleaning step that includes cleaning the urethane material (e.g., in a vapor degreaser) prior to contacting the urethane material with a cleaning solvent. A vapor degreaser is a well-known pre-cleaning methodology that includes heating a solvent so that it forms vapor-rich environment within a container and placing an article (e.g., CCA and/or individual CCA component) in the vapor degreaser so that the vapor can condense on the article in a manner that helps clean the article.

Processes of removing conformal coating according to the present invention allow articles, which are useful but otherwise typically disposed of because of having a conformal coating thereon, to be recovered and reused. This is especially significant with respect to urethane conformal coatings since they are so difficult to remove.

Articles that are recovered can be incorporated into an assembly (e.g., circuit card assembly). Methods of making circuit card assemblies are well-known.

An example of using a conformal coating removal process according to the present invention includes removing a ball grid array (BGA) component from a CCA having a urethane conformal coating. According to the present invention the urethane conformal coating was selectively stripped from the CCA in the vicinity of the BGA component. The BGA component was then removed, replaced with a different BGA component, and the assembly was re-coated with a conformal coating material in the area where the conformal coating material was stripped.

Another example of using a conformal coating removal process according to the present invention includes removing a 68 pin ceramic quad flat pack (CQFP68) component from a CCA having a urethane conformal coating. According to the present invention the urethane conformal coating was selectively stripped from the CCA in the vicinity of the CQFP68 component. The CQFP68 component was then removed, replaced with a different CQFP68 component, and the assembly was re-coated with a conformal coating material in the area where the conformal coating material was stripped.

What is claimed is:

1. A process of removing at least a portion of a conformal coating from an article comprising the steps of:
a) providing an article that includes a conformal coating;
b) providing a containment structure on the article such that the containment structure surrounds an area that includes at least a portion of the conformal coating;
c) providing an amount of a cleaning solvent in the area surrounded by the containment structure and in contact with the conformal coating within the area, wherein the amount of cleaning solvent is effective to help remove at least a portion of the conformal coating within the area; and
d) allowing the cleaning solvent to contact the conformal coating within the area in a manner so as to help remove at least a portion of the conformal coating.

2. The process of claim 1, wherein the step of providing a containment structure comprises forming a moldable material into at least part of a wall that surrounds at least part of the area so as to help form the containment structure.

3. The process of claim 2, wherein the moldable material comprises solder mask material and the process further comprises the step of curing the solder mask material.

4. The process of claim 1, wherein the conformal coating comprises a urethane material.

5. The process of claim 4, wherein the urethane material is formed from a ultra-violet light curable urethane precursor material.

6. The process of claim 1, wherein the height of the containment structure is sufficient to contain an amount of the cleaning solvent that forms a layer that is at least about 0.125 inches thick.

7. The process of claim 1, further comprising the step of causing the cleaning solvent to form a skin layer.

8. The process of claim 1, wherein the step of allowing the cleaning solvent to contact the conformal coating within the area helps remove substantially all of the conformal coating.

9. The process of claim 1, wherein the step of allowing the cleaning solvent to contact the conformal coating within the area comprises scrubbing the conformal coating while the cleaning solvent contacts the conformal coating so as to help remove substantially all of the conformal coating.

10. The process of claim 1, wherein the cleaning solvent is allowed to contact the conformal coating material for at least about 16 hours.

11. The process of claim 1, further comprising the step of, after the step of allowing the cleaning solvent to contact the conformal coating, rinsing the area with a rinsing liquid comprising methanol.

12. The process of claim 11, further comprising the step of repeating steps c) and d) at least once.

13. The process of claim 1, wherein the article comprises a circuit card assembly.

14. The process of claim 1, wherein the process does not include a pre-cleaning step comprising cleaning the conformal coating prior to contacting the conformal coating with the cleaning solvent.

15. An article recovered from the process of claim 1.

16. The article of claim 15, wherein the article is a circuit card assembly.

17. The article of claim 15, wherein the article is a circuit card assembly component.

18. A refurbished circuit card assembly comprising the recovered circuit card assembly of claim 16.

19. A circuit card assembly comprising the recovered circuit card assembly component of claim 17.

20. A process of using the recovered article of claim 15 comprising the step of incorporating the recovered article of claim 15 into a circuit card assembly.
